(19) United States
(12) Patent Application Publication
(10) Pub. No.: US 2017/0086450 A1
(43) Pub. Date: Mar. 30, 2017

(54) Hunting Blind

(71) Applicant: Larry C. Thompson, Inman, KS (US)

(72) Inventor: Larry C. Thompson, Inman, KS (US)

(73) Assignees: Larry C. Thompson, Inman, KS (US); Timothy L. Woolsey, Hutchinson, KS (US)

(21) Appl. No.: 15/377,781

(22) Filed: Dec. 13, 2016

(51) Int. Cl. A01M 31/02; E04H 15/64; E04H 15/44; E04H 15/00; E04H 15/54

(52) U.S. Cl. CPC A01M 31/025; E04H 15/001; E04H 15/54; E04H 15/44; E04H 15/64

(57) ABSTRACT

A hunting blind incorporating a left “U” bracket arm including a first rectangular frame having a left surface, and having longitudinal and oppositely longitudinal ends; a right “U” bracket arm having a second rectangular frame, having a right surface, and having longitudinal and oppositely longitudinal ends; a “U” bracket web having a longitudinal segmented beam and an oppositely longitudinal segmented beam, each of the beams having a medial segment and having left and right end segments wherein the beams' left end segments form rightwardly opening sockets and the beams' right end segments form leftwardly opening sockets; and a plurality of spring pin and eye fasteners, each such fastener attaching one of the “U” bracket web's sockets to one of the “U” bracket web's medial sections.

### FIELD OF THE INVENTION

This invention relates to hunting blinds of the type which are utilized at the banks of ponds and lakes in facilitation of duck hunting. More particularly, this invention relates to such blinds which include modular and portable components.

### BACKGROUND OF THE INVENTION

Commonly known water fowl hunting blind assemblies include numerous cumbersome and heavy parts, and such blinds often are difficult to assemble and disassemble. Also, such commonly known hunting blinds present or create difficulties in attaching and detaching camouflaging foliage. Such blinds also commonly present overhead obstacles and structures which may undesirably interfere with a hunter's targeting motions which include rising within the blind, shouldering a shotgun weapon, and swinging the weapon for target acquisition.

The instant inventive hunting blind solves or ameliorates problems discussed above by incorporating within the blind's assembly a longitudinally oblongated “U” bracket which incorporates specialized structures and features.

### BRIEF SUMMARY OF THE INVENTION

A major structural component of the instant inventive hunting blind comprises a “U” bracket having left and right arms, and having a web portion which spans laterally between lower or proximal ends of such arms. While a hunter of average height is seated within the inventive hunting blind upon a stool or chair having a seat height of 18 inches, such hunter's seated height is typically approximately 54 inches. In order to provide camouflage in coverage of such seated hunter, the “U” bracket's arms are preferably sized to extend upwardly or distally from their lower proximal ends a distance between 50 and 60 inches.

The instant inventive hunting blind may be sized for accommodating one to three hunters. Where there is intended to accommodate only a single hunter, the “U” bracket's arms preferably have a longitudinal extension or length (i.e., the dimension which is orthogonal to the lateral span of the “U” bracket's arms) between 34 and 45 inches. Where two or three hunters are to be accommodated within the interior space of the hunting blind, the left and right “U” bracket arms components preferably have a longitudinal length between 80 and 96 inches, such lengths being commensurate with the dimensions of a common pickup truck load bed. In the preferred embodiment, each of the “U” bracket's arms comprises a rigid ladder frame weldment and, for purposes of durability and lightness, such frames are preferably composed of square tube aluminum stock.

In a preferred embodiment of the instant invention, the “U” bracket's web component comprises longitudinal and oppositely longitudinal segmented beams having lengths between 34 and 45 inches. In the preferred embodiment, each segmented beam is composed of aluminum tubing having a circular cross section. Each of such web forming beams preferably comprises a combination of a medial section and left and right end segments wherein the end segments are respectively configured as rightwardly opening and leftwardly opening sockets. The inside diameters of such socket configured end segments preferably are closely fitted to the outside diameters of the medial segments so that the end segments may nestingly receive the medial sections' ends in the manner of quill and stem combinations.

Left and right ends of the web's socket segments are preferably fixedly welded to lower ends of the left and right ladder frame weldments, and releasable mounting means are preferably provided for releasably securing the left and right ends of the web's medial segments within such sockets. In the preferred embodiment, the releasable mounting means comprise finger depressible spring pin and alignable eye combinations. Suitably, the releasable mounting means may alternatively comprise sheer pin and aligned eyes combinations. Also suitably, the releasable mounting means may comprise slide fitted, pressure fitted, or helical screw attachments.

Further structural components of the instant inventive hunting blind comprise left and right cattle panels which are fitted for abutting, overlying, and substantially completely covering the left and right surfaces of the preferably provided left and right ladder frame weldments. A second plurality of mounting means are preferably provided for releasably interconnecting the left and right cattle panels with the “U” brackets' left and right arms, such means preferably comprising a plurality of “J” hooks. The second plurality of releasable mounting means may suitably alternatively comprise snap fasteners or band clamps. In a preferred embodiment, flexible plastic cable ties are provided for attaching camouflaging foliage to the vertical and longitudinal bars of the left and right cattle panel.

In use of the instant inventive hunting blind, the left and right ladder frame weldments, and the left and right cattle panels may be initially conveniently stored and transported upon the bed of a pickup truck. Other hunting blind components such as the “U” bracket web's medial bars or segments, cable ties, and camouflaging foliage may also be initially stored and transported within the pickup truck. In such truck bed storage, the cattle panels and the “U” bracket's rectangular frame arms may compactly rest in a vertical stack. An individual rectangular frame may be easily carried by two hunters from the truck bed to a blind set-up site, with one hunter grasping the frame's longitudinal rung and the other hunter grasping the frame's oppositely longitudinal rung. The blind's cattle panel components advantageously have sufficient longitudinal rigidity to allow a similar mode of carriage by the two hunters. The instant invention allows a large amount of camouflage foliage to be preliminarily attached to the cattle panels, and upon doing so, the rigidity of the cattle panel components advantageously allow for convenient two person carriage of the panel and foliage combinations.

Upon carriage of each of the blind's components to the set-up site, the components may be easily and conveniently snapped together into their “U” bracket configuration with the left and right cattle panels conveniently hung upon “J” hooks attached to the left and right ladder frame weldments.

Upon complete assembly of the “U” bracket configured hunting blind as described above, the upper or distal rails of the left and right ladder frame weldments advantageously define an upper obstruction free gun swing zone. According to the function of the blind's gun swing zone, a hunter seated upon a stool or chair within the hunting blind may, upon viewing a target, freely rise within the interior of the hunting blind, and may swing his or her shotgun upwardly through such zone without any structural interference with such movements.

Accordingly, objects of the instant invention include the provision of a hunting blind which incorporates structures as described above, and which arranges those structures in relation to each other in manners described above for the achievement of the beneficial functions described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a perspective view of a partially assembled configuration of the instant inventive hunting blind.

FIG. 2 is a partial sectional view of the structure of FIG. 1, as indicated in FIG. 1.

FIG. 3 redepicts the structure of FIG. 1, the view of FIG. 3 further showing installed cattle panel components.

FIG. 4 redepicts the structure of FIGS. 1 and 3, the view of FIG. 4 further showing installation of camouflaging foliage.

### DETAILED DESCRIPTION OF A PREFERRED EMBODIMENT

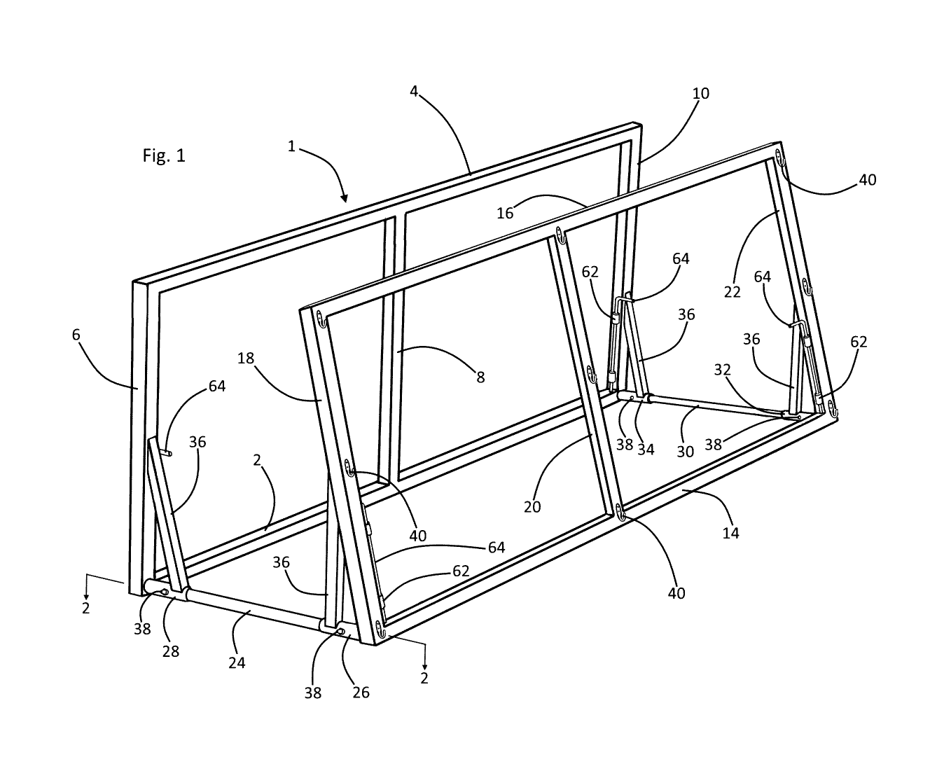

Referring now to the drawings and in particular to Drawing FIG. 1, a preferred embodiment of the instant inventive hunting blind includes a longitudinally oblongated “U” bracket which is referred to generally by Reference Arrow. 1. The “U” bracket 1 has a left “U” bracket arm which preferably is configured as a rectangular ladder frame weldment having a lower rail 2, an upper rail 4, a longitudinal rung 6, a medial rung 8, and an oppositely longitudinal rung 10. For purposes of lightness and durability, such left ladder frame weldment is preferably composed of square tube aluminum stock. The “U” bracket component 1 of the instant invention preferably further comprises a right “U” bracket arm which is similarly configured as an aluminum ladder frame weldment having lower and upper rails 14 and 16, and having longitudinal, medial, and oppositely longitudinal vertically extending rungs 18, 20, and 22.

The “U” bracket 1 preferably further comprises a lower web which spans laterally between the lower or proximal ends of the “U” bracket's left and right arms. Such web preferably comprises longitudinal and oppositely longitudinal beams, the longitudinal beam having a medial segment 24, a right end segment 26, and a left end segment 28, and the oppositely longitudinal beam having a medial segment 30, a right end segment 32, and a left end segment 34. Each of the right end segments 26 and 32 is preferably configured as a leftwardly opening socket, such sockets preferably being fitted for respectively nestingly receiving the right ends of the medial segments 24 and 30. The left end segments 28 and 34 are preferably similarly configured as rightwardly opening sockets which are fitted for nestingly receiving the left ends of the medial segments 24 and 30. Proximal or base ends of the sockets 26, 28, 32, and 34, are preferably welded to the extreme longitudinal and oppositely longitudinal ends of the “U” bracket's left and right arms, such welded attachments residing at such arm's proximal ends.

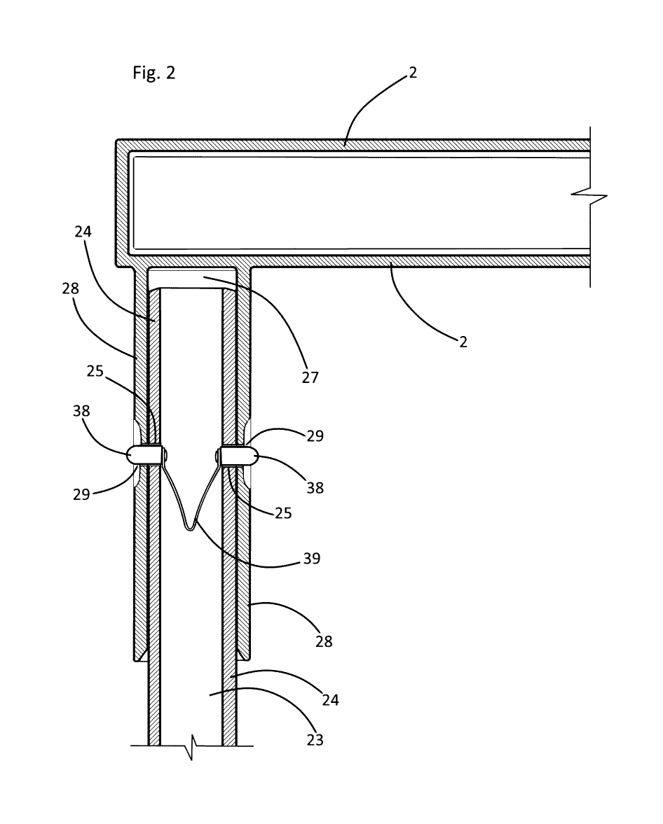

Referring simultaneously to FIGS. 1 and 2, a plurality of releasable mounting means are preferably provided for connecting the left and right ends of the web's medial sections 24 and 30 with the sockets 28, 34, 26, and 32. In a preferred embodiment, such releasable mounting means comprise combinations of finger depressible pins 38 which are normally outwardly or leftwardly and rightwardly biased by “Y” springs 39 mounted within bores 27. Opposing eyes 25 within the left and right ends of the medial sections 24 and 30 permanently slidably receive the sheer pins 38, while the “Y” springs 39 secure such pins 38 in place. Upon insertion of the left and right ends of the medial sections 24 and 30 into the hollow bores 27 of the sockets 28, 34, 26, and 32, socket eyes 29, and pins 28, may come into alignments which allow the pins 28 to extend outwardly therethrough, locking the medial sections 24 and 32 in their “U” bracket web forming configurations. Opposing finger pressure applied inwardly against the pins 38 may allow for easy and convenient disengagement of the releasable fastening means, allowing for convenient disassembly of the hunting blind. The spring biased pins 38 in combination with alignable eyes 24 and 25 and 29 are intended as being representative of other suitably substituted releasable mounting means such as single sheer pin and alignable eyes combinations, and screw fittings.

For additional durability and rigidity of the invention's “U” bracket, triangulating gusset bars 36 are preferably fixedly welded to and span between the sockets 26, 28, 32, and 36, and 34 and the longitudinal and oppositely longitudinal ladder frame rungs 16, 18, 10, and 22.

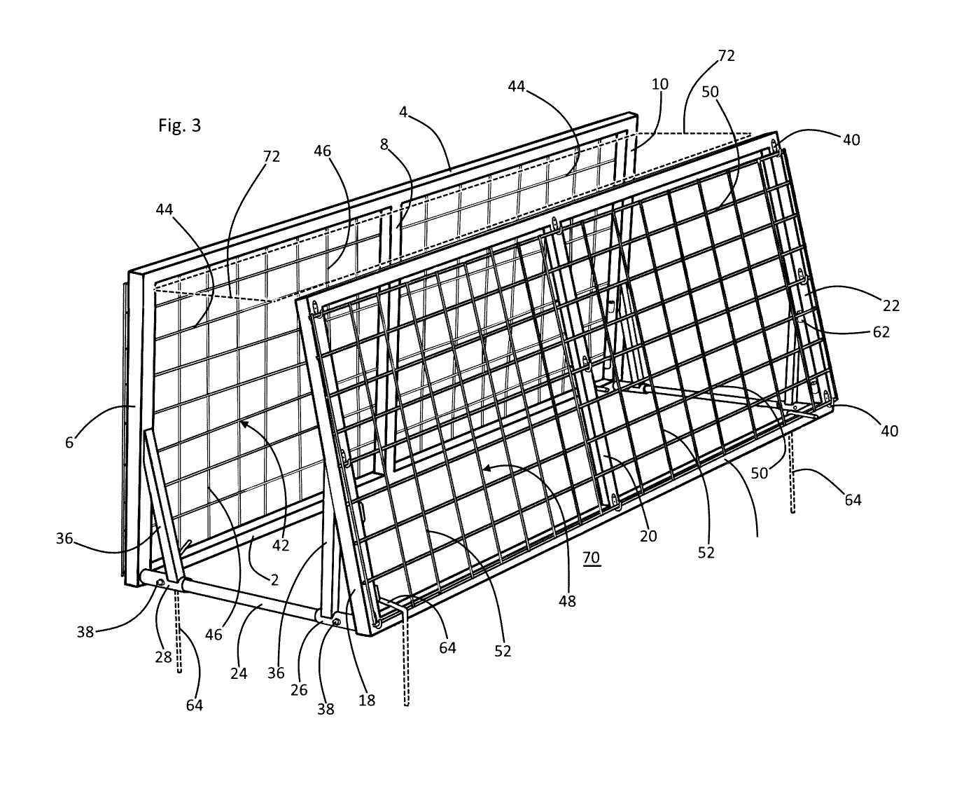

Referring to FIG. 3, the instant inventive hunting blind further comprises left and right cattle panels 42 and 48, such panels having pluralities of longitudinally extending bars 44 and 50, and having pluralities of vertically extending bars 46 and 52, such bars being welded at their intersecting joints. In the preferred embodiment, such intersecting bars have diameters or thicknesses between 3/16 inches and ⅜ inches.

A second plurality of releasable mounting means are preferably provided for interconnecting the left and right cattle panels 42 and 48 with the “U” bracket's left and right arms. In a preferred embodiment, such second releasable mounting means comprise a plurality of “J” hooks 40 which may engage the longitudinally extending bars of the cattle panels 42 and 48. The “J” hooks 40 are intended as being representative of other suitably substituted releasable mounting means such as snap fasteners, and tie bands.

In order to secure the instant inventive hunting blind upon a ground surface 70, “L” headed stakes 64 are preferably provided. As indicated in FIG. 3, stakes 64 may be driven downwardly into the ground 70 through application of foot pressure against the stakes' “L” configured heads. Thereafter, the “L” heads of the stakes 64 may be turned to engage rails 2 and 14. In order to conveniently store the stakes 64 upon disassembly of the hunting blind, third releasable mounting means preferably in the form of sleeves 62 are preferably provided, such sleeves 62 being welded to the longitudinal and oppositely longitudinal weldment rungs 6, 18, 10, and 22.

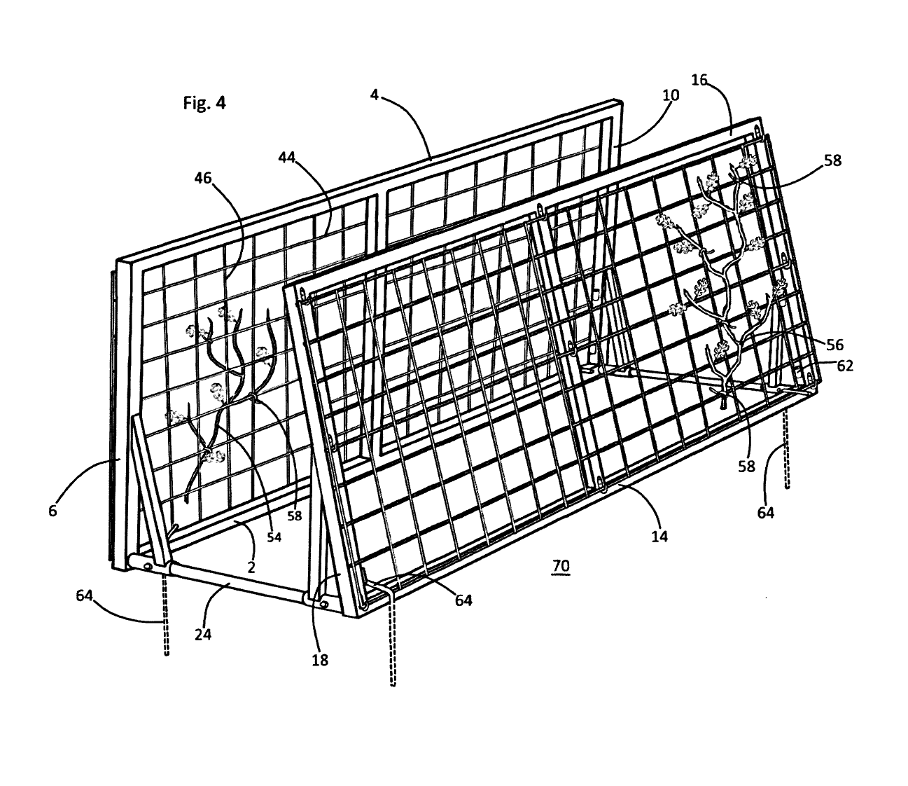

Upon assembly of the inventive hunting blind as indicated in FIG. 3, and referring further simultaneously to FIG. 4, a plurality of foliage branches or stems 54 and 56 may be obtained and provided for attachment to the cattle panels 42 and 48. To secure such foliage, a fourth plurality of releasable mounting means, preferably in the form of cable ties 58, are preferably provided. Alternatively, or in addition, stretchable shock or “bungee” cord and hook combinations may be utilized for securing such foliage 54 and 56 upon the cattle panels 42 and 48.

Upon assembly of the hunting blind as indicated in FIGS. 3 and 4, an obstruction free gun swing zone 72 is advantageously formed, such zone allowing a hunter to freely upwardly move a firearm over rails 4 and 16 without impinging contact with any structure.

While the principles of the invention have been made clear in the above illustrative embodiment, those skilled in the art may make modifications to the structure, arrangement, portions and components of the invention without departing from those principles. Accordingly, it is intended that the description and drawings be interpreted as illustrative and not in the limiting sense, and that the invention be given a scope commensurate with the appended claims.

The invention hereby claimed is:

1. A hunting blind comprising:
(a) a left “U” bracket arm, said arm comprising a first rectangular frame having a left surface and having longitudinal and oppositely longitudinal ends;
(b) a right “U” bracket arm, said arm comprising a second rectangular frame and having a right surface and having longitudinal and oppositely longitudinal ends;
(c) a “U” bracket web comprising a longitudinal segmented beam and an oppositely longitudinal segmented beam, each of said beams having a medial segment and having left and right end segments, said beams' left end segments comprising rightwardly opening sockets, and said beams' right end segments comprising leftwardly opening sockets; and
(d) a plurality of releasable mounting means, each releasable mounting means among the plurality of releasable mounting means attaching one of said web's sockets to one of said web's medial sections.

2. The hunting blind of claim 1 comprising left and right cattle panels, and further comprising a second plurality of releasable mounting means, said means respectively attaching the left and right cattle panels to the left and right “U” bracket arms.

3. The hunting blind of claim 2 wherein the first and second rectangular frames respectively comprise left and right ladder frame weldments.

4. The hunting blind of claim 3 wherein the left and right cattle panels respectively comprise first and second pluralities of longitudinally extending bars, and wherein the second plurality of releasable mounting means comprise a plurality of “J” hooks, each “J” hook engaging one of the longitudinally extending bars.

5. The hunting blind of claim 4 wherein each releasable mounting means among the plurality of releasable mounting means comprises a spring biased pin and eye combination.

6. The hunting blind of claim 5 wherein each weldment among the left and right ladder frame weldments comprises a longitudinal rung and an oppositely longitudinal rung, and further comprising a plurality of gusset stays, each gusset stay triangulating between one of said rungs and one of the sockets.

7. The hunting blind of claim 6 wherein each weldment among the left and right ladder frame weldments has an upper rail having longitudinal and oppositely longitudinal ends, and further comprising a gun swing zone spanning between said upper rails and extending between said longitudinal and oppositely longitudinal ends.

8. The hunting blind of claim 7 comprising a plurality of stakes, and further comprising a third plurality of releasable mounting means, said means positioning the stakes upon at least one of the weldments among the left and right ladder frame weldments, each stake having an “L” head for ladder frame engagement.

9. The hunting blind of claim 8 wherein the third plurality of releasable mounting means comprise a plurality of sleeves, each stake being fitted for downward extension through one of the sleeves.

10. The hunting blind of claim 9 comprising a plurality of foliage stems, and further comprising a fourth plurality of releasable mounting means, said means attaching the foliage stems to the left and right cattle panels.

11. The hunting blind of claim 10 wherein the fourth plurality of releasable mounting means comprise a plurality of cable ties or a plurality of shock cord and hook combinations.
